(19) United States
(12) Patent Application Publication
(10) Pub. No.: US 2009/0225040 A1
(43) Pub. Date: Sep. 10, 2009

(54) CENTRAL RESOURCE FOR VARIABLE ORIENTATION USER INTERFACE

(75) Inventor: Chris Whytock, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/042,302

(22) Filed: Mar. 4, 2008

(51) Int. Cl. G09G 5/00; G06F 3/041

(52) U.S. Cl. 345/173; 345/156

(57) ABSTRACT

An interactive media display system includes a display surface including a touch-sensitive region; a processing subsystem operatively coupled to the display surface; computer-readable media operatively coupled to the processing subsystem and including system instructions that, when executed by the processing subsystem: determine an initial user orientation relative to the display surface; receive an orientation query from an application; and return an orientation query response to the application, the orientation query response identifying the determined initial user orientation.

### BACKGROUND

Computer display surfaces can present graphical information to users. Some computer display surfaces may be configured to accommodate users at different orientations relative to the display surface. When accommodating users at different orientations, the graphical information may be presented to each user at an appropriate orientation relative to the user.

Applications that are executed by an operating system of the computer display surface may assume the same orientation as other applications when presenting their graphical information. Furthermore, some operating systems may dictate an orientation to the application for presenting their graphical information.

### SUMMARY

Various approaches for communicating orientation information associated with the presentation of graphical information via an interactive media display system are described below in the Detailed Description. As described herein, each application may be executed by the media display system to query an operating system of the media display system (e.g. via an API) to obtain orientation information upon which the application may independently prescribe an appropriate orientation for the presentation of graphical information on the display surface. In at least some examples, the prescribed orientation may be ultimately decided by the application, not the operating system. This approach recognizes that some applications may present their graphical information to users in different ways, and while information from the operating system may be useful to the applications when prescribing an orientation, the application may deviate from an orientation that is suggested by the operating system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an interactive media display system capable of providing system-level orientation information to one or more applications.

FIG. 2 is a schematic depiction of instructions that may be executed by the interactive media display system of FIG. 1.

FIGS. 3-5 are schematic depictions of example process flows that may be executed by the interactive media display system of FIG. 1.

FIG. 6 schematically illustrates a timeline of the interactive media display system of FIG. 1 providing system-level orientation information to two different applications.

FIG. 7 is a schematic depiction of an interactive media display system.

### DETAILED DESCRIPTION

The present disclosure is directed to an approach for facilitating the presentation of graphical information of an interactive media display system that can accommodate users at different user orientations relative to a display surface of the interactive media display system. As one non-limiting example, system instructions defining an operating system of the interactive media display system can serve as a central resource for orientation information that may be readily accessed by one or more applications. This orientation information may include the relative orientation of both users and graphical user interfaces with respect to the display surface. By providing the applications with a centralized source of orientation information, the applications can prescribe appropriate orientations at which their respective graphical user interfaces are presented to the user. While the present disclosure employs an interactive media display system including a touch-sensitive display surface as a non-limiting example of a computing device that can accommodate users at different orientations, it should be understood that other suitable computing devices can be used in accordance with the present disclosure, including computing devices that do not employ touch sensitive display surfaces.

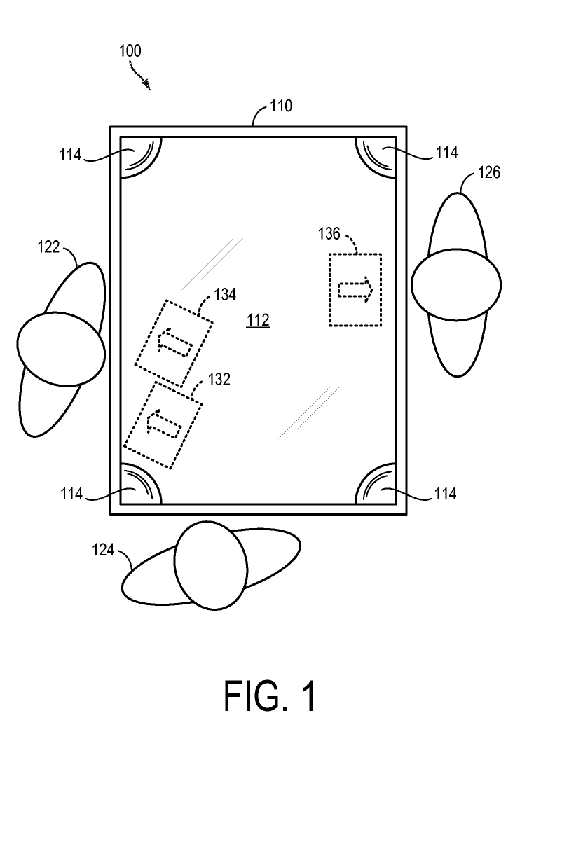

FIG. 1 is a schematic depiction of an interactive media display system 100. The example interactive media display system 100 includes a display surface 110. In this particular example, display surface 110 is configured as a touch-sensitive display surface including a touch-sensitive region 112. One or more user inputs may be received from one or more users by the interactive media display system via touch-sensitive region 112. However, interactive media display system 100 can additionally or alternatively receive user inputs by other suitable user input devices.

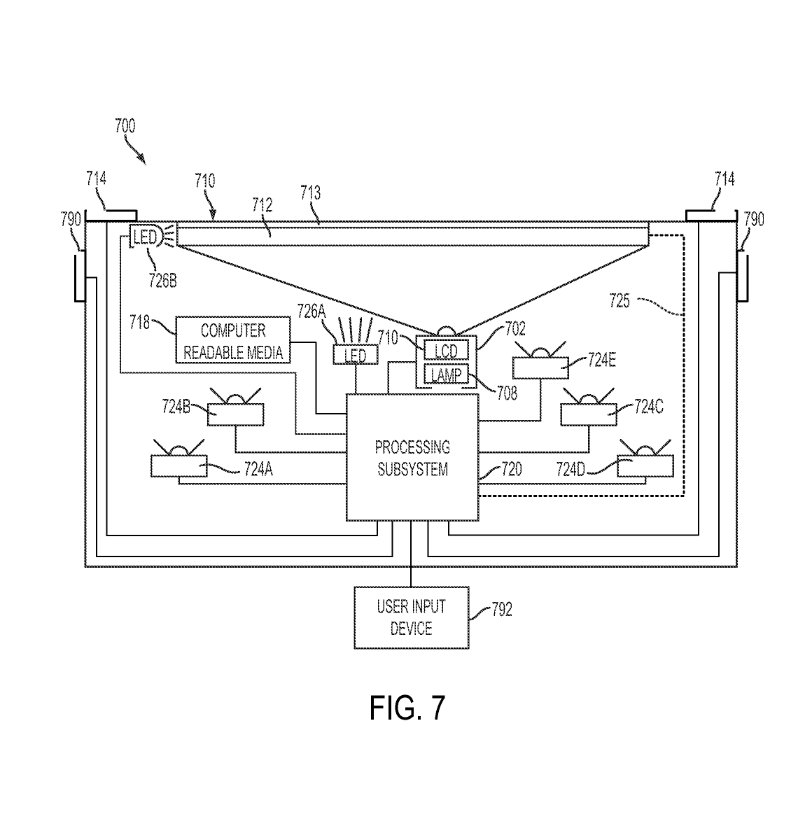

As a non-limiting example, interactive media display system 100 may include one or more buttons located at or disposed along a perimeter of display surface 110 for receiving a user input. As one non-limiting example, a button may be located at each corner of the display surface as indicated at 114. The interactive media display system 100 may include still other suitable user input devices as will be described in greater detail with reference to FIG. 7. These user inputs can be used by the interactive media display system to determine and respond to user orientation.

Interactive media display system 100 can execute various instructions, including system instructions and application instructions. As one non-limiting example, the interactive media display system 100 can execute instructions that cause the display surface to present graphical information, including one or more graphical user interfaces, at orientations that are prescribed by their respective application or by the operating system. The display surface, in this example, is shown displaying several graphical user interfaces at 132, 134, and 136. Each of the graphical user interfaces schematically depicted in FIG. 1 includes an arrow that represents an orientation of the graphical user interface.

Each of users 122, 124, and 126 can interact with applications via the depicted graphical user interfaces. As one non-limiting example, by touching the touch-sensitive region of the display surface upon which the graphical user interface is displayed, a user may interact with an application defining the graphical user interface. For example, user 126 can interact with graphical user interface 136 by touching the touch-sensitive region on or near graphical user interface 136.

In some instances, two or more users may interact with the same application via a common graphical user interface. For example, each of users 122 and 124 can interact with graphical user interfaces 132 and 134, however, graphical user interfaces 132 and 134 are each oriented relative to user 122 as indicated by the their respective arrows. In resolving the issue of multiple users, a prescribed orientation for a graphical user interface can be identified by the application in response to a dominant user of the application. As one example, the dominant user for an application can be identified by a characteristic of the different user inputs that are received by the interactive media display system. The graphical user interface defined by the application can then be orientated relative to the dominant user by the interactive media display system in accordance with the prescribed orientation.

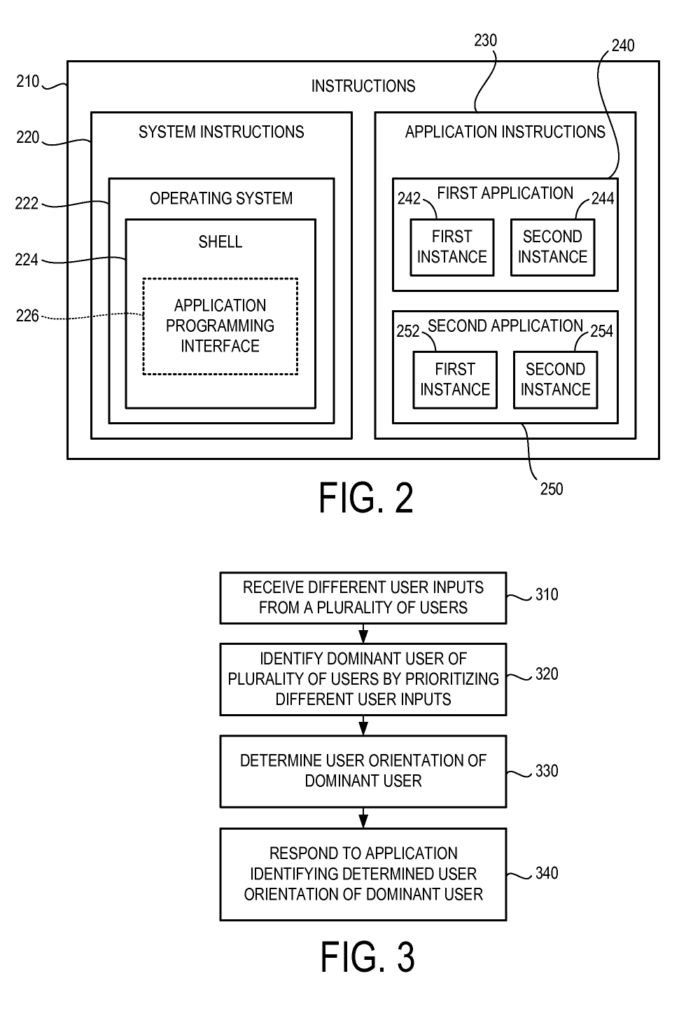

FIG. 2 is a schematic depiction of at least some of the instructions that may be executed by the interactive media display system. As shown in FIG. 2, these instructions, as indicated at 210, can include system instructions 220 and application instructions 230.

System instructions can refer to any suitable instruction that may be executed by the interactive media display system to manage and control the interactive media display system so that the application instructions can perform a task. As one non-limiting example, system instructions can define an operating system 222 of the interactive media display system and may further define a shell 224. As will be described herein, shell 224 can serve as a central source of orientation information associated with each user of the interactive media display system and/or each graphical user interface that is displayed.

Application instructions 230 can define one or more applications. For example, a first application 240 and a second application 250 are depicted schematically. Further, the application instructions can define one or more instances of each application. For example, first application 240 can include a first instance 242 and a second instance 244. Further still, each of these instances can define a respective graphical user interface that may be displayed on the display surface. Thus, each graphical user interface can enable a user to interact with a particular application or instance of an application.

For example, referring also to FIG. 1, first instance 242 of application 240 can define graphical user interface 132, while second instance 244 of application 240 can define graphical user interface 136. Thus, in this particular example, two or more users may interact with different instances of the same application via their respective graphical user interfaces.

Similarly, second application 250 may include one or more instances as indicated at 252 and 254. Instances 252 and 254 can define other graphical user interfaces that are the same as or different than the graphical user interfaces of instances 242 and 244. For example, instance 252 can define graphical user interface 134 of FIG. 1. In this way, user 122 can interact with applications 240 and 250 via graphical user interfaces 132 and 134, respectively.

Applications can interact with the operating system to employ the capabilities of the interactive media display system to a task that the users wish to perform. For example, each of the applications can communicate with the shell to facilitate the display and/or orientation of their graphical user interfaces on the display surface. As one non-limiting example, the system instructions can utilize an application programming interface (API), or shell-side aspects of an API, as indicated at 226. Among other abilities, the API may allow the shell and the applications to communicate orientation information with one another. As described herein, an API may refer to any suitably defined communicative interface between the shell and the applications, and may be represented by any suitable logic for defining the communicative interface.

FIG. 3 is a schematic depiction of an example process flow that may be executed by the interactive media display system as directed by at least the system instructions. At 310, the system instructions, when executed by the interactive media display system, can receive different user inputs from a plurality of users. For example, the different user inputs may be received via one or more of touch-sensitive region 112, buttons 114, or another suitable user input device.

As one example, the interactive media display system can receive one or more user inputs from user 122 via touch-sensitive region 112 within a general vicinity of graphical user interfaces 132 and 134, while the interactive media display system can also receive one or more user inputs from user 126 within a general vicinity of graphical user interface 136 via the touch-sensitive region of the display surface. Additionally, the interactive media display system can receive one or more user inputs from user 124 via at least one of the buttons indicated at 114.

At 320, the system instructions, when executed by the interactive media display system, can optionally identify a dominant user of the plurality of users for each application or each application instance by prioritizing the different user inputs received at 310. As one non-limiting example, one or more characteristics of the user inputs received at 310 may be used by the interactive media display system to denote user orientation relative to each graphical user interface and/or may be used to denote dominance of a particular user relative to other users with respect to a given graphical user interface.

As one non-limiting example, different user inputs that are received by the interactive media display system may be prioritized by the operating system for each application or for each instance of an application. For example, the shell can optionally identify user 126 as the dominant user for an instance of a first application that defines graphical user interface 136 where a characteristic of the user input received from user 126 denotes a higher priority than the user input received from users 122 and 124. As another example, the shell can optionally identify user 122 as the dominant user for each instance of a second application that defines graphical user interfaces 132 and 134 where a characteristic of the user input received from user 122 denotes a higher priority than the user input received from users 124 and 126.

As a non-limiting example, the shell may establish priority for each of the user inputs received by the interactive media display system based on characteristics including: proximity of the user input relative to a graphical user interface of the application or instance of the application, a temporal order at which the user inputs are received by the interactive display surface, a number of user inputs received from a particular user, an inferred orientation of an individual input, among others and combinations thereof. The temporal order at which the user inputs are received may refer to establishing priority based upon a first input received, a last input received, a frequency of inputs received by a user, etc. It should be appreciated that the various concepts described herein should not be limited by the specific approach applied by the interactive media display system for identifying the dominant user.

At 330, the system instructions, when executed by the interactive media display system, can determine a user orientation of the dominant user for each application or each instance of an application. As one non-limiting example, the shell can determine a user orientation of a dominant user relative to the display surface based on a characteristic of one or more user inputs received from the dominant user. In determining the user orientation of the dominant user, the system instructions, when executed by the interactive media display system, can assess one or more of the user inputs attributed to the dominant user, including: the location of each user input of the dominant user relative to the graphical user interface of the application, shadowing effects caused by the dominant user's hand, finger, or other touching implement that are received by the display surface, and user prescribed settings for the dominant user, among others. Further, in some examples, the interactive media display system may also determine user orientation of non-dominant users of the interactive media display surface as described with reference to the dominant user.

At 340, the system instructions, when executed by the interactive media display system, can respond to each application or each instance of an application by identifying the user orientation of the dominant user of the application or instance of the application determined at 330. In some examples, the system instructions may also cause the shell to respond to each application identifying the user orientation of non-dominant users of the application that may also be determined by the interactive media display system.

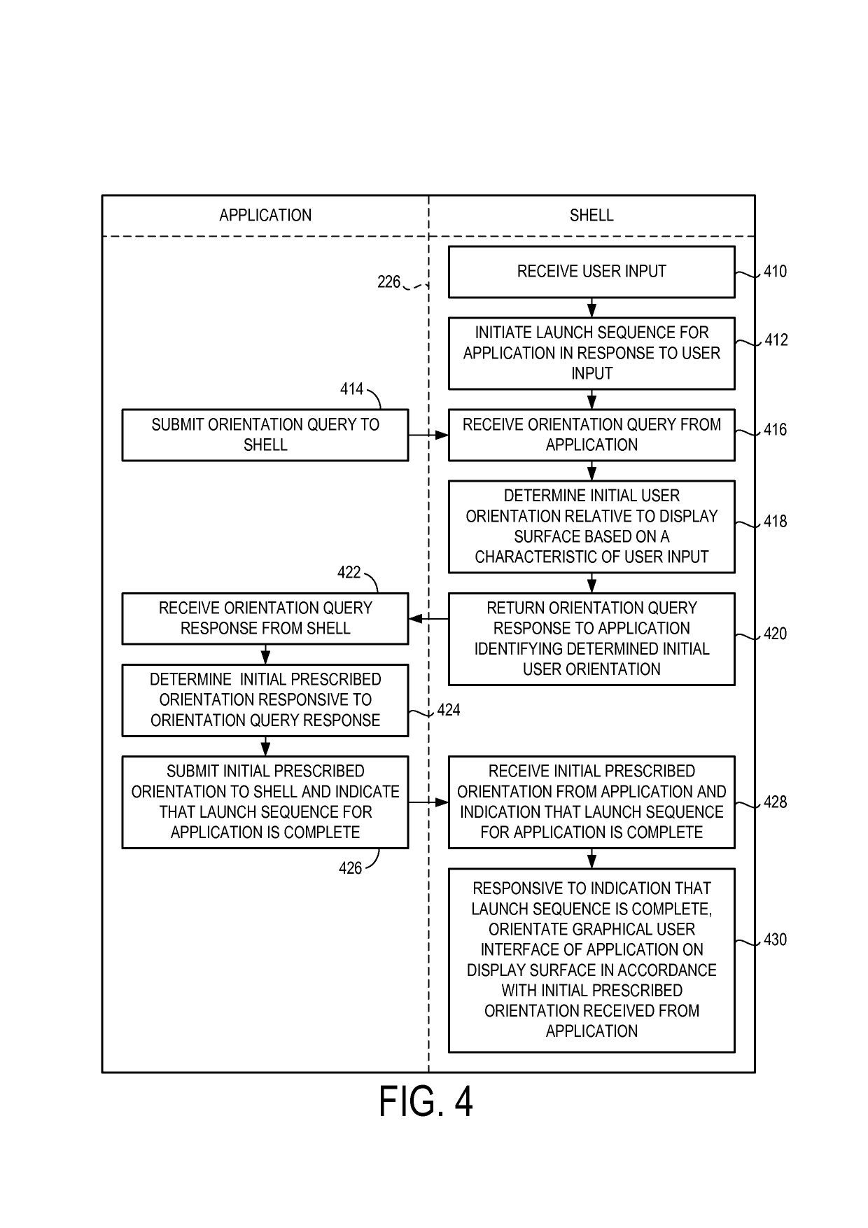

FIG. 4 is a schematic depiction of an example process flow that may be executed by the interactive media display system as directed by the system instructions and the application instructions. The process flow of FIG. 4 depicts a method of providing system-level orientation information to an application on a computing system such as interactive media display system 100. As a non-limiting example, an interaction between a first application and the shell of the operating system via API 226 is described.

At 410, the system instructions, when executed by the interactive media display system, can receive a user input. The user input received at 410 may be one of a plurality of different user inputs from one or more users. For example, as previously described with reference to 310, the interactive media display system can receive different user inputs from a plurality of users via the touch-sensitive region of the display surface or another suitable user input device.

At 412, the system instructions, when executed by the interactive media display system, can initiate a launch sequence for an application in response to the user input received at 410. As one non-limiting example, the system instructions may cause the interactive media display system to initiate a launch sequence for a select instance of an application in response to the user input. However, it should be appreciated that in some examples, the system instructions can also initiate a launch sequence for an application without first receiving a user input.

At 414, the application instructions, when executed by the interactive media display system, can submit an orientation query to the operating system of the interactive media display system via the API of the shell. As one example, the application can submit the orientation query to the shell via the API during the launch sequence for the application.

At 416, the system instructions, when executed by the interactive media display system, can receive the orientation query from the application. For example, the shell can receive the orientation query from the application during the launch sequence. In some examples, the system instructions may cause the interactive media display system to display a loading screen during the launch sequence for the application before the graphical user interface of the application is displayed on the display surface and the launch sequence is terminated. For example, the loading screen may be displayed on the display surface at a default orientation or an orientation prescribed by the operating system, which can be based on the user input received by the interactive media display system.

At 418, the system instructions, when executed by the interactive media display system, can determine an initial user orientation relative to the display surface. As previously described, the initial user orientation determined at 418 can be based on a characteristic of the user input received at 410. Further, in some examples, the initial user orientation may be determined for each user of the interactive media display system or may be determined for only the dominant user of the application or instance of the application as previously described, for example, at 330. The initial orientation may be determined before or after the application submits an orientation query to the shell.

At 420, the system instructions, when executed by the interactive media display system, can return an orientation query response to the application, the orientation query response in this example is identifying the determined initial user orientation. For example, the shell can return the orientation query response to the application via the API.

At 422, the application instructions, when executed by the interactive media display system, can receive the orientation query response from the shell, the orientation query response in this example is identifying the initial user orientation relative to the display surface. As a non-limiting example, the orientation query response can identify the initial user orientation of the dominant user of the application or an instance of the application as described at 330. However, in other examples, the orientation query response can identify the initial user orientation for each user of a plurality of users.

At 424, the application instructions, when executed by the interactive media display system, can determine an initial prescribed orientation based on the orientation query response received from the operating system. While the orientation information that is received from the operating system, including the orientation query response, may be helpful in determining the initial prescribed orientation, the application may deviate from an orientation that is suggested by the orientation query response when determining the initial prescribed orientation. In this way, each application can be free to prescribe its own orientation, and each application is not confined to an orientation that is dictated by the shell. At the same time, each application is free to leverage orientation information that is provided by the shell in determining a prescribed orientation. In some embodiments, system instructions may optionally take a more authoritative role, in at least some circumstances, forcibly re-orientating aspects of an application's graphical user interface instead of merely suggesting an orientation.

As used herein, the initial prescribed orientation defines an orientation at which the graphical user interface of the application is to be displayed on the display surface. Further, as will be described, a prescribed orientation update may be determined by the application in response to a change in user orientation. Therefore, as used herein, the prescribed orientation update also defines an orientation at which the graphical user interface of the application is to be displayed on the display surface.

In at least some examples, each application may be permitted to determine an initial prescribed orientation or a prescribed orientation update without the shell determining the initial prescribed orientation or prescribed orientation update on behalf of the application.

At 426, the application instructions, when executed by the interactive media display system, can submit to the shell the initial prescribed orientation determined at 424 and an indication that the launch sequence for the application is complete. Again, the application can communicate with the shell via the API as defined by the system instructions.

At 428, the system instructions, when executed by the interactive media display system, can receive, via the API, the initial prescribed orientation from the application and the indication that the launch sequence for the application is complete.

At 430, the system instructions, when executed by the interactive media display system, can orientate a graphical user interface of the application or instance of the application on the touch-sensitive display surface in accordance with the initial prescribed orientation received from the application.

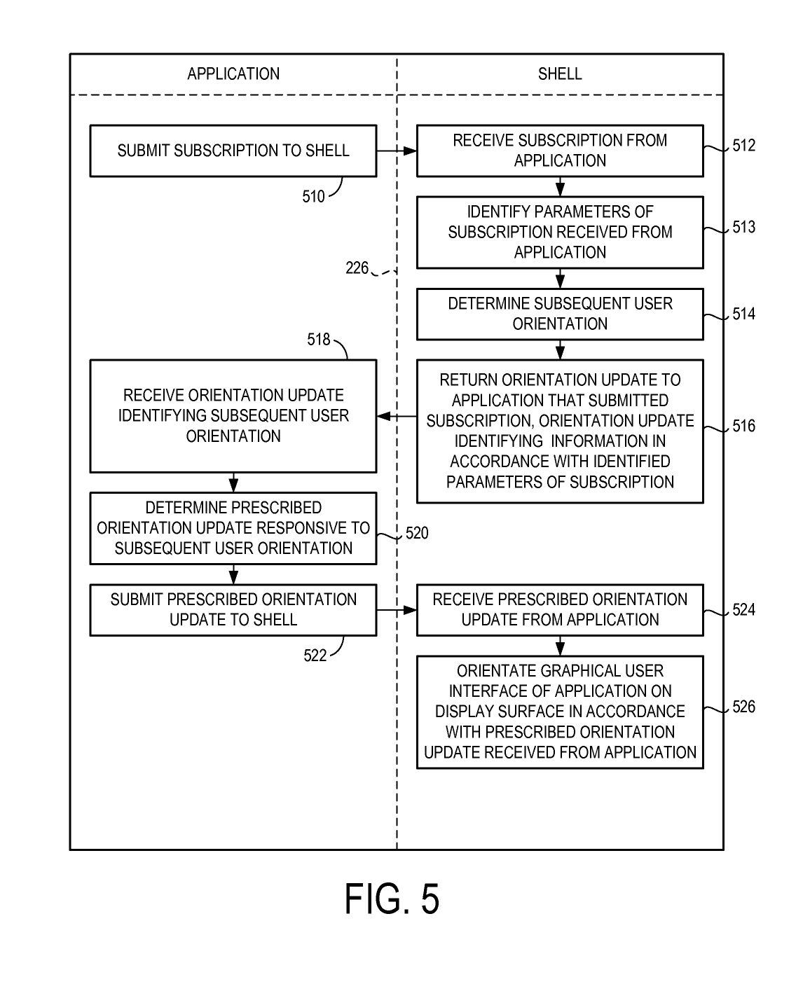

FIG. 5 is a schematic depiction of an example process flow that may be executed by the interactive media display system as directed by the system instructions and the application instructions. The process flow of FIG. 5 depicts a method of providing system-level orientation information to an application on a computing system such as interactive media display system 100. As one non-limiting example, the process flow of FIG. 5 may be executed by the interactive media display system after the process flow of FIG. 4 is executed.

For example, at 510, the application instructions, when executed by the interactive media display system, can submit a subscription to the shell via API 226. As one example, the subscription may include a request for the shell to return a subsequent user orientation update in response to the shell perceiving a subsequent change in user orientation. At 512, the system instructions, when executed by the interactive media display system, can receive the subscription from the application. Again, as previously described with reference to FIG. 4, the shell and the application can communicate via API 226.

At 513, the system instructions, when executed by the interactive media display system, can identify parameters of the subscription that was received from the application. These parameters may specify the type of orientation information that the shell is to return to the application.

At 514, the system instructions, when executed by the interactive media display system, can determine the subsequent user orientation. For example, referring also to FIG. 1, user 122 may move from a first position represented by user 124 to a second position depicted at 122 in FIG. 1. Where the user has moved after the orientation query response has been returned to the application by the shell, for example, as described at 420, the subsequent user orientation may be determined for the new orientation of the user. Again, the subsequent user orientation can be determined according to a characteristic of the user input as previously described with reference to FIG. 3, or via any other suitable method.

At 516, the system instructions, when executed by the interactive media display system, can return an orientation update to the application that submitted the subscription via the API, where the orientation update can identify orientation information in accordance with the parameters of the subscription that were identified at 513. In this particular example, the orientation update is identifying at least the determined subsequent user orientation. The determined subsequent user orientation may correspond to an orientation of only the dominant user of the application or instance of the application, or may correspond to an orientation of some or all of a plurality of users of the interactive media display system.

At 518, the application instructions, when executed by the interactive media display system, can receive the orientation update identifying the subsequent user orientation via the API. At 520, the application instructions, when executed by the interactive media display system, can determine a prescribed orientation update responsive to the user orientation update received from the shell. While the orientation information that is received from the operating system, including the orientation update, may be helpful in determining the prescribed orientation update, the application may deviate from the orientation that is suggested by the orientation update when determining the prescribed orientation update.

At 522, the application instructions, when executed by the interactive media display system, can submit the prescribed orientation update to the shell via the API. At 524, the system instructions, when executed by the interactive media display system, can receive the prescribed orientation update from the application via the API.

At 526, the system instructions, when executed by the interactive media display system, can orientate a graphical user interface of the application or of an instance of the application on the display surface in accordance with the prescribed orientation update received from the application at 524. For example, if the graphical user interface of the application is displayed at a first orientation, it may be orientated to a second orientation in accordance with the prescribed orientation update. However, where the prescribed orientation update is unchanged from the initial prescribed orientation that was previously submitted by the application, the graphical user interface of the application may continue to be displayed at the same orientation.

As when initially determining the prescribed orientation, an application is free to consider all orientation information received from the shell, and can determine how much weight to give to such orientation information when determining the initial prescribed orientation or the orientation update. Therefore, in at least some examples, the prescribed orientation is ultimately decided by the application, not the shell.

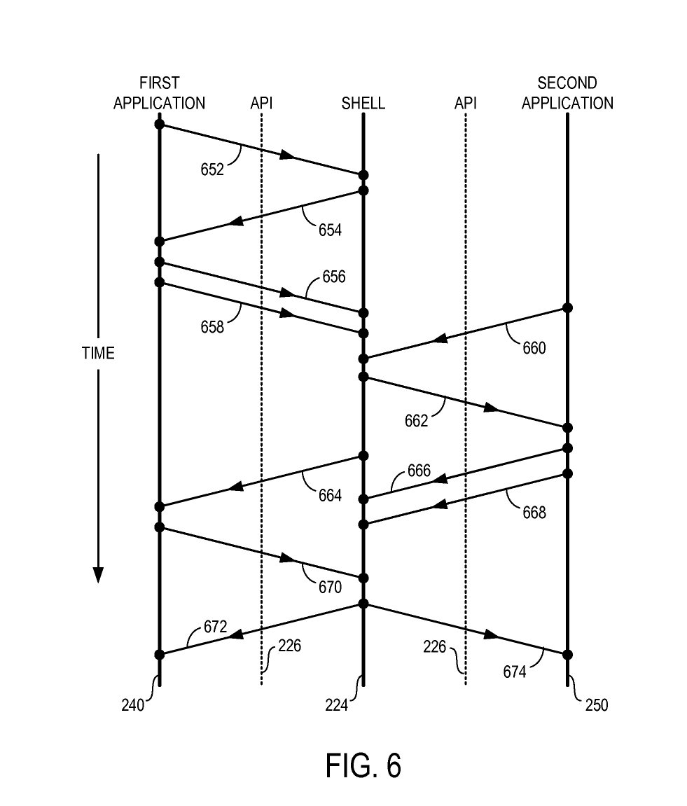

FIG. 6 schematically illustrates a timeline of the interactive media display system providing system-level orientation information to two different applications. In this example, a first application and a second application, as defined by executed application instructions, are schematically represented as vertical lines 240 and 250, respectively. Note that the first and second applications may alternatively refer to first and second instances of the same application. The shell, as defined by the system instructions, is schematically represented as vertical line 224. Further, the API is represented as broken vertical lines 226. Note that while two lines are depicted for the API, the API can be defined by the system instructions as a single API by which each of a plurality of applications can communicate with the shell. In the diagram of FIG. 6, time is represented along the vertical axis.

Beginning at 652, the first application submits an orientation query to the shell via the API. As previously described with reference to FIG. 4, the first application can submit the orientation query to the shell during the launch sequence of the first application. However, it should be appreciated that in other examples, an application can submit an orientation query to the shell at any suitable time in order to receive an orientation query response from the shell.

As indicated at 654, the shell can return an orientation query response to the first application via the API in response to receiving the orientation query from the first application. Thus, in this example, the shell returns the orientation query response to the application that submitted the orientation query. As described with reference to 424 of FIG. 4, the first application can determine an initial prescribed orientation upon receiving the orientation query response and can submit the initial prescribed orientation to the shell via the API, as indicated at 656. Note that in other examples, the first application may submit the initial prescribed orientation to another suitable location of the operating system in order to display a graphical user interface of the first application at an orientation that is in accordance with the initial prescribed orientation.

As indicated at 658, the first application can submit a subscription to the shell via the API. It should be appreciated that the subscription may be submitted to the shell by the first application during the launch sequence before the graphical user interface of the first application is initially displayed at the initial prescribed orientation, or the first application can submit the subscription to the shell subsequent to completion of the launch sequence as indicated at 658.

Referring also to the second application, a second orientation query may be received by the shell from the second application via the API as indicated at 660. As one example, a launch sequence for the second application may be initiated in response to a user input received from a user of the first application. Alternatively, a launch sequence for the second application may be initiated in response to a user input received from a different user that is not associated with the first application, or the operating system or another application may initiate the launch sequence independent of user input.

As indicated at 662, the shell can return a second orientation query response to the second application that identifies the determined initial user orientation for the user of the second application. The second application can determine an initial prescribed orientation in response to the second orientation query response and can submit the initial prescribed orientation to the shell as indicated at 666, whereby a graphical user interface of the second application can be displayed on the display surface upon completion of the launch sequence for the second application.

Returning briefly to the first application, as indicated at 664, the shell can return an orientation update to the first application that submitted the subscription at 658. The orientation update can identify a subsequent user orientation for the user of the first application. For example, the user of the first application may have moved relative to the display surface as indicated by a characteristic of the user input received by the interactive media display system. Alternatively, where two users are each interacting with the same graphical user interface, the dominant user may have changed, thereby causing the shell to return an orientation update to the application that submitted the subscription, which identifies the determined subsequent user orientation of the new dominant user.

As indicated at 670, the first application can submit a prescribed orientation update to the shell via the API. The prescribed orientation update can be determined by the first application in response to the user orientation update received from the shell as indicated at 664. The graphical user interface of the first application can be orientated by the operating system in accordance with the prescribed orientation update submitted at 670.

As indicated at 668, the second application can also submit a subscription to the shell. Where both the first application and the second application have subscribed to the shell by submitting their respective subscriptions, the shell can return user orientation updates to each application upon an assessment of a subsequent user orientation. These user orientation updates can be returned by the shell in accordance with the parameters of the relevant subscription. For example, the shell can return an orientation update to both the first application and the second application identifying a subsequent user orientation for some or all of the users.

Further, the orientation update returned at 672 can be the same or different as the orientation update returned at 674. For example, the orientation update returned to the first application at 672 and the orientation update returned to the second application by the shell at 674 can each identify a subsequent user orientation of a user of the first application. Alternatively, the orientation update returned to the first application at 672 can identify a subsequent user orientation of only the dominant user of the first application, while the orientation update returned to the second application at 674 can identify a subsequent user orientation of only the dominant user of the second application In this way, each application can specify the type of orientation information that the shell will return via the orientation updates as defined by the parameters of the subscription.

Further still, in some examples, the orientation update returned to the first application as indicated at 672 can further identify the initial prescribed orientation that was submitted to the shell by the second application at 666 in addition to the determined subsequent user orientation. Similarly, the orientation update returned to the second application as indicated at 674 can further identify the prescribed orientation update that was submitted to the shell by the first application as indicated at 670.

In this way, multiple applications can each subscribe to the shell to receive orientation information regarding a user orientation for a user of the subscribing application, but can also identify an initial user orientation for users of other applications, a subsequent user orientation for users of other applications, an initial prescribed orientation submitted to the shell by a different application, and/or a prescribed orientation update submitted to the shell by a different application.

As discussed above, the interactive media display system can execute various instructions, including system instructions and/or application instructions. FIG. 7 shows a schematic depiction of a non-limiting example of an interactive media display system 700 capable of executing the process flows described herein. It should be understood that devices other than those depicted by FIG. 7 can be used to carry out the various approaches described herein without departing from the scope of the present disclosure.

Interactive media display system 700 in this example includes a projection display system having an image source 702 that can project images onto display surface 710. Image source 702 can include an optical or light source 708, such as the depicted lamp, an LED array, or other suitable light source. Image source 702 may also include an image-producing element 710, such as the depicted LCD (liquid crystal display), an LCOS (liquid crystal on silicon) display, a DLP (digital light processing) display, or any other suitable image-producing element. Display screen 710 may include a clear, transparent portion 712, such as a sheet of glass, and a diffuser screen layer 713 disposed on top of the clear, transparent portion 712. In some embodiments, an additional transparent layer (not shown) may be disposed over diffuser screen layer 713 to provide a smooth look and feel to the display surface. In this way, transparent portion 712 and diffuser screen layer 713 can form a non-limiting example of a touch-sensitive region of display surface 710 as previously described with reference to 112.

Continuing with FIG. 7, interactive media display system 700 may further include a processing subsystem 720 and computer-readable media 718 operatively coupled to the processing subsystem 720. Processing subsystem 720 may be operatively coupled to display surface 710. As previously described with reference to FIG. 1, display surface 710, in at least some examples, may be configured as a touch-sensitive display surface. Processing subsystem 720 may include one or more processors for executing instructions that are stored at the computer-readable media. The computer-readable media may include the previously described system instructions and/or application instructions. The computer-readable media may be local or remote to the interactive media display system, and may include volatile or non-volatile memory of any suitable type. Further, the computer-readable media may be fixed or removable relative to the interactive media display system.

The instructions described herein can be stored or temporarily held on computer-readable media 718, and can be executed by processing subsystem 720. In this way, the various instructions described herein, including the system and application instructions, can be executed by the processing subsystem, thereby causing the processing subsystem to perform one or more of the operations previously described with reference to the process flow. It should be appreciated that in other examples, the processing subsystem and computer-readable media may be remotely located from the interactive media display system. As one example, the computer-readable media and/or processing subsystem can communicate with the interactive media display system via a local area network, a wide area network, or other suitable communicative coupling, via wired or wireless communication.

To sense objects that are contacting or near to display surface 710, interactive media display system 700 may include one or more image capture devices 724A-724E configured to capture an image of the backside of display surface 710, and to provide the image to processing subsystem 720 for the detection of objects appearing in the image. The diffuser screen layer 713 can serve to reduce or avoid the imaging of objects that are not in contact with or positioned within a few millimeters or other suitable distance of display surface 710, and therefore helps to ensure that at least objects that are touching transparent portion 712 of display surface 710 are detected by image capture devices 724A-724E.

Image capture devices 724A-724E may include any suitable image sensing mechanism. Examples of suitable image sensing mechanisms include but are not limited to CCD and CMOS image sensors. Further, the image sensing mechanisms may capture images of display surface 710 at a sufficient frequency to detect motion of an object across display surface 710. Display surface 710 may alternatively or further include an optional capacitive, resistive or other electromagnetic touch-sensing mechanism, as illustrated by dashed-line connection 725 of display surface 710 with processing subsystem 720.

Image capture devices 724A-724E may be configured to detect reflected or emitted energy of any suitable wavelength, including but not limited to infrared and visible wavelengths. To assist in detecting objects placed on display surface 710, image capture devices 724A-724E may further include an additional optical source or emitter such as one or more light emitting diodes (LEDs) 726A and/or 726B configured to produce infrared or visible light. Light from LEDs 726A and/or 726B may be reflected by objects contacting or near display surface 710 and then detected by image capture devices 724A-724E. The use of infrared LEDs as opposed to visible LEDs may help to avoid washing out the appearance of projected images on display surface 710.

In some examples, one or more of LEDs 726A and/or 726B may be positioned at any suitable location within interactive media display system 700. In the example of FIG. 7, a plurality of LEDs may be placed along a side of display surface 710 as indicated at 726B. In this location, light from the LEDs can travel through display surface 710 via internal reflection, while some light can escape from display surface 710 for reflection by an object on the display surface 710. In other examples, one or more LEDs indicated at 726A may be placed beneath display surface 710 so as to pass emitted light through display surface 710.

As described herein, the interactive media display system can receive various user inputs from one or more users via user input devices other than the touch-sensitive display surface and the buttons indicated at 714. For example, as indicated at 790, the interactive media display system may receive user input via a motion sensor or user identification reader that may be operatively coupled with processing subsystem 720. As another example, a user input device 792 may reside external the interactive media display system, and may include one or more of a keyboard, a mouse, a joystick, camera, or other suitable user input device. User input device 792 may be operatively coupled to processing subsystem 720 by wired or wireless communication. In this way, the interactive media display surface can receive user input by various user input devices that enable the electronic controller to determine user orientation in accordance with the disclosure.

It will be appreciated that the configurations and/or approaches described herein are exemplary in nature, and that these specific embodiments or examples are not to be considered in a limiting sense, because numerous variations are possible. For example, while described herein in the context of an interactive media display system having a horizontal, table-like display surface, it will be appreciated that the concepts described herein may also be used with displays of other suitable orientation, including vertically arranged displays.

Furthermore, the specific process flows or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the exemplary embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. An interactive media display system, comprising:
a display surface including a touch-sensitive region;
a processing subsystem operatively coupled to the display surface;
computer-readable media operatively coupled to the processing subsystem and including system instructions that, when executed by the processing subsystem, causes the processing subsystem to:
determine an initial user orientation relative to the display surface;
receive an orientation query from an application; and
return an orientation query response to the application, the orientation query response identifying the determined initial user orientation.

2. The interactive media display system of claim 1, wherein the computer-readable media further includes system instructions that, when executed by the processing subsystem, causes the processing subsystem to:
receive a subscription from the application;
determine a subsequent user orientation relative to the display surface; and
return an orientation update to the application that submitted the subscription, the orientation update identifying the determined subsequent user orientation.

3. The interactive media display system of claim 2, wherein the computer-readable media further includes system instructions that, when executed by the processing subsystem, causes the processing subsystem to:
receive different user inputs from a plurality of users via the touch-sensitive region of the display surface;
determine the subsequent user orientation of a dominant user of the plurality of users by prioritizing the different user inputs received via the touch-sensitive region of the display surface; and
return the orientation update to the application, the orientation update identifying the determined subsequent user orientation of the dominant user of the application.

4. The interactive media display system of claim 1, wherein the computer-readable media further includes system instructions that, when executed by the processing subsystem, causes the processing subsystem to:
receive a user input from a user; and
determine the initial user orientation relative to the display surface based on a characteristic of the user input.

5. The interactive media display system of claim 4, wherein the user input is received from the user via the touch-sensitive region of the display surface.

6. The interactive media display system of claim 4, wherein the user input is received from the user via one of a plurality of buttons located at a perimeter of the display surface.

7. The interactive media display system of claim 4, wherein the computer-readable media further includes system instructions that, when executed by the processing subsystem, causes the processing subsystem to:
initiate a launch sequence for the application in response to the user input received from the user; and
receive the orientation query from the application during the launch sequence of the application.

8. The interactive media display system of claim 1, wherein the system instructions define an application programming interface by which the orientation query is received from the application and the orientation query response is returned to the application.

9. The interactive media display system of claim 1, wherein the computer-readable media further includes system instructions that, when executed by the processing subsystem, causes the processing subsystem to:
receive an initial prescribed orientation from the application; and
orientate a graphical user interface of the application on the display surface in accordance with the initial prescribed orientation received from the application.

10. The interactive media display system of claim 9, wherein the computer-readable media further includes system instructions that, when executed by the processing subsystem, causes the processing subsystem to:
receive a second orientation query from a second application; and
return the orientation query response to the second application in response to the received second orientation query, the orientation query response identifying the determined initial user orientation and further identifying the initial prescribed orientation received from the application.

11. A method of providing system-level orientation information to an application on a computing system, comprising:
determining an initial user orientation relative to a display surface of the computing system;
receiving an orientation query from an application during a launch sequence of the application;
returning an orientation query response to the application, the orientation query response identifying the determined initial user orientation;
receiving a subscription from the application;
determining a subsequent user orientation relative to the display surface of the computing system; and
returning an orientation update to the application from which the subscription was received, the orientation update identifying the determined subsequent user orientation.

12. The method of claim 11, wherein determining the initial user orientation relative to the display surface of the computing system includes receiving a user input via a touch-sensitive region of the display surface.

13. The method of claim 11, wherein the orientation query and the subscription are received from the application via an application programming interface.

14. The method of claim 11, further comprising, receiving a second orientation query from a second application; and returning a second orientation query response to the second application, the second orientation query response identifying the determined initial user orientation.

15. The method of claim 11, further comprising, receiving a second orientation query from a second application; and returning a second orientation query response to the second application, the second orientation query response identifying the orientation update.

16. The method of claim 11, further comprising, receiving a second subscription from a second application; and returning the orientation update to the second application from which the second subscription was received, the orientation update identifying the determined subsequent user orientation.

17. The method of claim 11, further comprising,
receiving an initial prescribed orientation from the application after the orientation query response is returned to the application; and
orientating a graphical user interface of the application on the display surface in accordance with the initial prescribed orientation received from the application.

18. The method of claim 11, further comprising, wherein determining the initial user orientation relative to a display surface of the computing system includes identifying a first user orientation for a first user and a second user orientation for a second user; and wherein the orientation query response returned to the application includes an indication of the first user orientation and the second user orientation.

19. The method of claim 11, wherein the initial user orientation and the subsequent user orientation are determined for a dominant user of the application.

20. A computer-readable media comprising application instructions that, when executed by a processing subsystem, causes the processing subsystem to:
submit an orientation query to an operating system via an application programming interface of the operating system;
receive an orientation query response from the operating system via the application programming interface, the orientation query response identifying an initial user orientation of a dominant user;
submit a subscription to the operating system via the application programming interface; and
receive an orientation update from the operating system after the orientation query response is received from the operating system, the orientation update identifying a subsequent user orientation of the dominant user.
